(19) United States
(12) Patent Application Publication
(10) Pub. No.: US 2003/0231112 A1
(43) Pub. Date: Dec. 18, 2003

(54) Secure parcel delivery with electronic notification and approval

(75) Inventor: Srikanth Raju, San Jose, CA (US)

Correspondence Address: David B. Ritchie, Thelen Reid & Priest LLP, P.O. Box 640640, San Jose, CA, 95164, US

(73) Assignee: Sun Microsystems, Inc., a Delaware Corporation

(21) Appl. No.: 10/174,732

(22) Filed: Jun. 18, 2002

(51) Int. Cl. G08B 13/14

(52) U.S. Cl. 340/569; 340/5.73

(57) ABSTRACT

A customized mailbox is provided to customers for placement outside their home. Simple electronics, such as a display, keypad, bar-code reader, and transmitter/receiver may be contained within the mailbox. When parcel delivery is attempted, the deliveryperson may facilitate the notification of the user by, for example, scanning a bar code on the parcel with the bar code reader. Parcel information is then wirelessly forwarded to a service provider. The service provider may forward parcel information a mobile device or other notification mechanism as specified in user preferences. Upon receipt of the parcel delivery information, the user may, through the mobile device or other notification mechanism, approve delivery of the parcel. The service provider may then forward this approval to the electronic mailbox, where an electronic lock may be opened and the deliveryperson may place the parcel in the electronic mailbox.

### FIELD OF THE INVENTION

The present invention relates to the fields of parcel delivery and mobile devices. More particularly, the present invention relates to secure parcel delivery with electronic notification and approval through wireless devices and other mechanisms.

### BACKGROUND OF THE INVENTION

Parcel delivery service through the United States Post Office (USPS) has existed since the birth of the country. In more recent years, competitors such as United Parcel Service (UPS) and Federal Express (Fedex) have burst onto the scene with new abilities to ship and track packages and parcels easily and efficiently. While the USPS still dominates the market when it comes to the delivery of letters, bills, and other low-priority information, UPS and Federal Express have taken the lead in package delivery and priority letter services.

Despite these and other competitors in this arena, package delivery is still typically a 9 to 5 operation. While this does not present a problem when a business receives a package, many individual consumers work during the day and cannot be home to sign for packages delivered to their homes. While some companies offer the option of having packages left at the front door, this presents a security problem as theft of these packages is quite common, especially in bad neighborhoods. Additionally, even if such delivery is safe, often a consumer needs to know urgently whether a package has been delivered despite not being home to receive the package.

What is needed is a solution which provides secure parcel delivery with instant notification to consumers of package delivery. What is also needed is a solution which allows a user to authorize delivery of a package instantaneously from a remote location.

### BRIEF DESCRIPTION OF THE INVENTION

A customized mailbox is provided to customers for placement outside their home. Simple electronics, such as a display, keypad, bar-code reader, and transmitter/receiver may be contained within the mailbox. When parcel delivery is attempted, the deliveryperson may facilitate the notification of the user by, for example, scanning a bar code on the parcel with the bar code reader. Parcel information is then wirelessly forwarded to a service provider. The service provider may forward parcel information a mobile device or other notification mechanism as specified in user preferences. Upon receipt of the parcel delivery information, the user may, through the mobile device or other notification mechanism, approve delivery of the parcel. The service provider may then forward this approval to the electronic mailbox, where an electronic lock may be opened and the deliveryperson may place the parcel in the electronic mailbox.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram illustrating a secure parcel mailbox in accordance with a specific embodiment of the present invention.

FIG. 2 is a flow diagram illustrating a method for secure parcel receipt at an electronic mailbox in accordance with a specific embodiment of the present invention.

FIG. 3 is a flow diagram illustrating a method for approving delivery of a parcel to a remote electronic mailbox in accordance with a specific embodiment of the present invention.

FIG. 4 is a flow diagram illustrating a method for coordinating approval of secure parcel delivery to an electronic mailbox in accordance with a specific embodiment of the present invention.

FIG. 5 is a block diagram illustrating an apparatus for approving delivery of a parcel to a remote electronic mailbox in accordance with a specific embodiment of the present invention.

FIG. 6 is a block diagram illustrating an apparatus for approving delivery of a parcel to a remote electronic mailbox in accordance with a specific embodiment of the present invention.

FIG. 7 is a block diagram illustrating an apparatus for coordinating approval of secure parcel delivery to an electronic mailbox in accordance with a specific embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In a specific embodiment of the present invention, a customized mailbox is provided to customers for placement outside their home. Simple electronics, such as a display, keypad, bar-code reader, and transmitter/receiver may be contained within the mailbox. The mailbox may communicate wirelessly with a secure parcel service provider (SPSP). When a delivery attempt is made, the deliveryperson may scan a bar code on the parcel using the barcode reader. The mailbox then transmits this information to the SPSP along with information about the mailbox. The SPSP reads this identity information, and then may select where to send an approval request based on pre-defined user preferences. For example, the user may have an Internet-connected cellular phone that is listed in his preferences. The SPSP may then forward the approval request to the cellular phone and await an approval response from the customer. Once that is received, the approval may be sent back to the mailbox, which may automatically open for placement of the parcel.

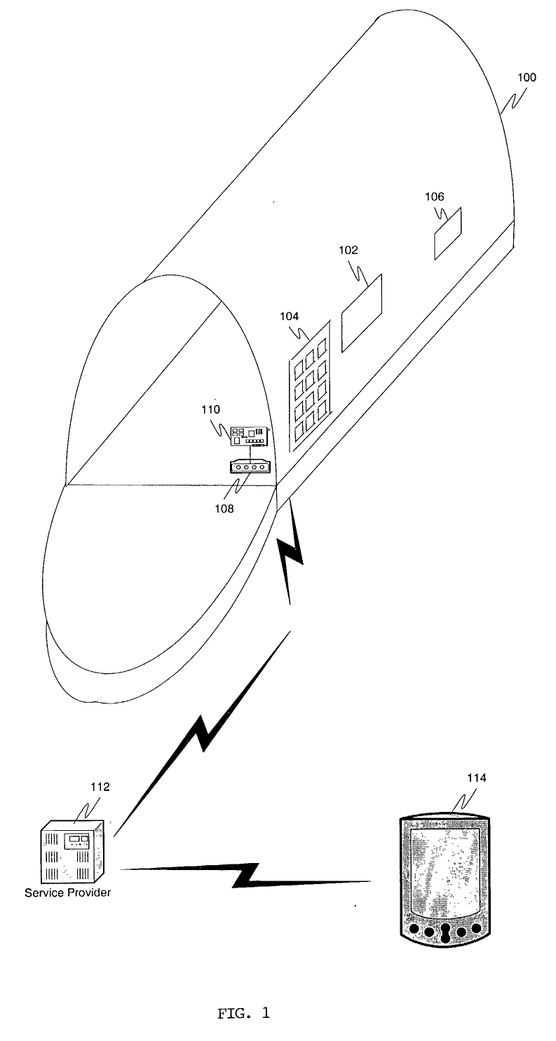

FIG. 1 is a block diagram illustrating a secure parcel mailbox in accordance with a specific embodiment of the present invention. The mailbox 100 may contain electronics such as a display 102, a keypad 104, a bar-code reader 106, and a wireless transmitter/receiver 108. Simple software such as may be contained on a Javacard™ 110 developed by Sun Microsystems, Inc. of Palo Alto, Calif. may be utilized in the mailbox to control the electronic components and facilitate the interfacing between them. The mailbox may communicate wirelessly with a service provider 112, which in turn may communicate with a mobile device 114.

Once a customer agrees to have this service, a password may be selected for the mailbox. The password may then be typed into the keypad 104 when a user wishes to open the mailbox. Alternatively, the user could open the mailbox remotely, such as through a web browser that can communicate with the mailbox. This would allow the user to call a neighbor on the phone and ask him to pick up the package without having to give away the password. In another embodiment, the user may swipe a JavaCard or similar authenticating card through a card reader.

The user may also utilize a web broswer to customize the preferences, such as how they would like to receive user notification, such as through a mobile device, personal data assistant (PDA), or computer through chat or messaging software such as Yahoo™ Messenger or Instant Messaging from AOL™. On the mobile device or PDA, the user may enter more details about their notification mechanism. For example they could select whether they want to be notified through Short Message Service (SMS) messaging or the invocation of a Java program such as MIDlet on a J2ME enabled device.

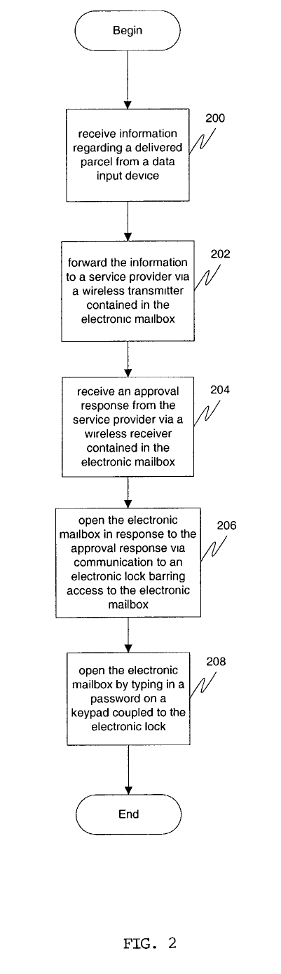

FIG. 2 is a flow diagram illustrating a method for secure parcel receipt at an electronic mailbox in accordance with a specific embodiment of the present invention. At 200, information is received regarding a delivered parcel from a data input device. The data input device may be, for example, a bar code reader and the receiving of information may include scanning a bar code attached to the parcel with a bar code reader. At 202, the information may be forwarded to a service provider via a wireless transmitter contained in the electronic mailbox. At 204, an approval response may be received from the service provider via a wireless receiver contained in the electronic mailbox. Alternatively, a blanket open request may be received. This allows a user to remotely open the mailbox even when parcel delivery is not being attempted. At 206, the electronic mailbox may be opened in response to the approval response via communication to an electronic lock barring access to the electronic mailbox. At 208, the electronic mailbox may be opened by typing in a password on a keypad coupled to the electronic lock.

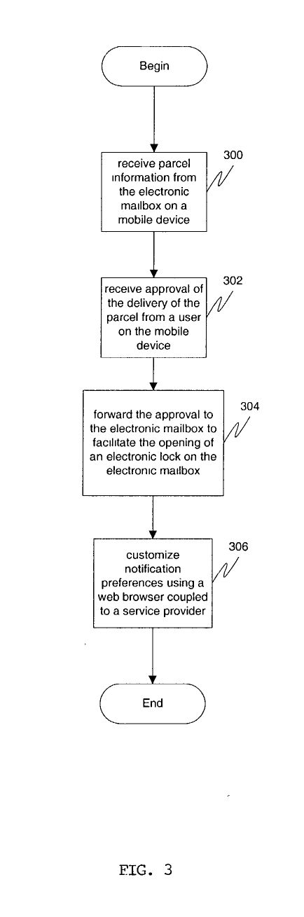

FIG. 3 is a flow diagram illustrating a method for approving delivery of a parcel to a remote electronic mailbox in accordance with a specific embodiment of the present invention. At 300, parcel information is received from the electronic mailbox on a mobile device. This may be received via a service provider. At 302, approval of the delivery of the parcel from a user may be received on the mobile device. This may include a user typing in an approval key sequence or selecting a window indicating approval on the mobile device. At 304, the approval may be forwarded to the electronic mailbox to facilitate the opening of an electronic lock on the electronic mailbox. This may be forwarded via a service provider. At 306, notification preferences may be customized using a web browser coupled to a service provider.

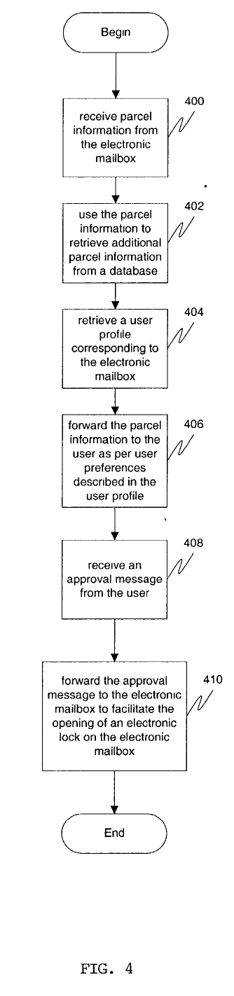

FIG. 4 is a flow diagram illustrating a method for coordinating approval of secure parcel delivery to an electronic mailbox in accordance with a specific embodiment of the present invention. At 400, parcel information is received from the electronic mailbox. At 402, the parcel information may be used to retrieve additional parcel information from a database. For example, if the parcel information is data retrieved from a bar code on the parcel, the database may contain information regarding the package linked to the bar code. This database may be maintained by the shipper. Thus, for example, UPS would scan the bar code at the mailbox. The bar code information would then be forwarded to UPS's database where package information such as shipper name could be retrieved. At 404, a user profile corresponding to the electronic mailbox may be retrieved. At 406, the parcel information may be forwarded to the user as per user preferences described in the user profile. At 408, an approval message may be received from the user. At 410, the approval message may be forwarded to the electronic mailbox to facilitate the opening of an electronic lock on the electronic mailbox.

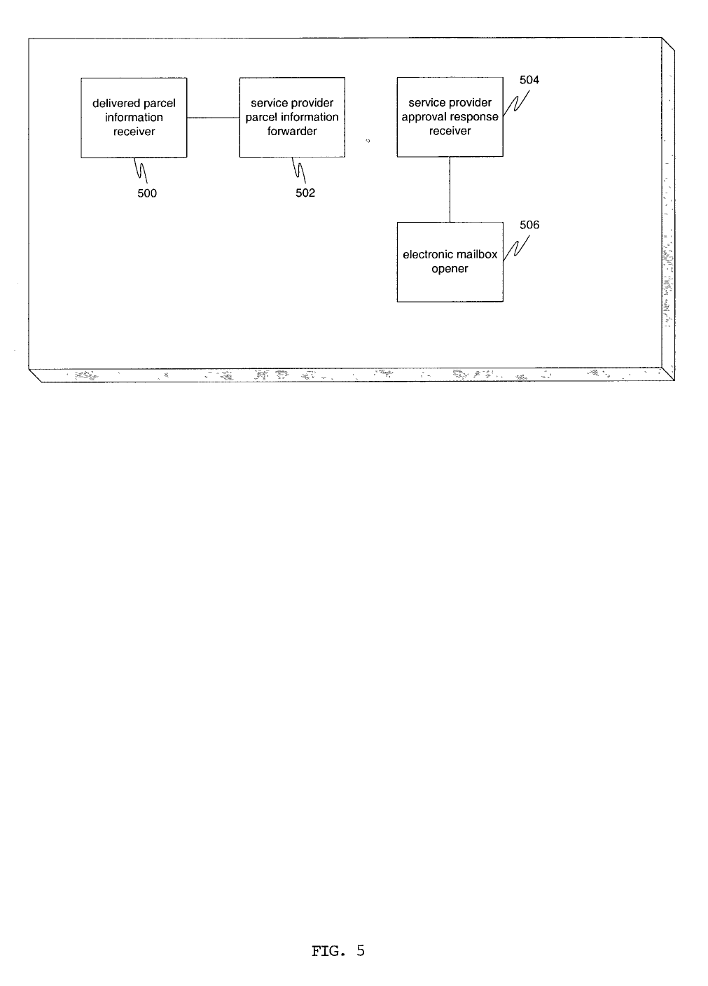

FIG. 5 is a block diagram illustrating an apparatus for approving delivery of a parcel to a remote electronic mailbox in accordance with a specific embodiment of the present invention. A delivered parcel information receiver 500 receives information regarding a delivered parcel from a data input device. The data input device may be, for example, a bar code reader and the receiving of information may include scanning a bar code attached to the parcel with a bar code reader. A service provider parcel information forwarder 502 coupled to the delivered parcel information receiver 500 may forward the information to a service provider via a wireless transmitter contained in the electronic mailbox. A service provider approval response receiver 504 may receive an approval response from the service provider via a wireless receiver contained in the electronic mailbox. Alternatively, a blanket open request may be received to collect the package even from a remote location. This allows a user to remotely open the mailbox even when parcel delivery is not being attempted. An electronic mailbox opener 506 coupled to the service provider approval response receiver 504 may open the electronic mailbox in response to the approval response via communication to an electronic lock barring access to the electronic mailbox. The electronic mailbox may also be opened by typing in a password on a keypad coupled to the electronic lock.

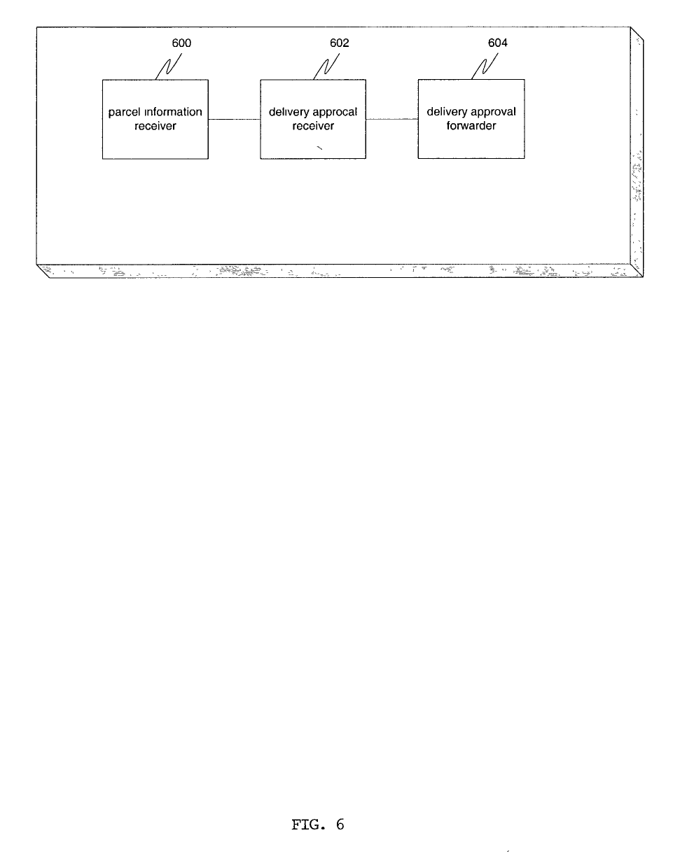

FIG. 6 is a block diagram illustrating an apparatus for approving delivery of a parcel to a remote electronic mailbox in accordance with a specific embodiment of the present invention. A parcel information receiver 600 receives parcel information from the electronic mailbox on a mobile device. This may be received via a service provider. A delivery approval receiver 602 coupled to the parcel information receiver 600 receives approval of the delivery of the parcel from a user on the mobile device. This may include a user typing in an approval key sequence or selecting a window indicating approval on the mobile device. A deliver approval forwarder 604 coupled to the delivery approval receiver 602 may forward the approval to the electronic mailbox to facilitate the opening of an electronic lock on the electronic mailbox. This may be forwarded via a service provider. Notification preferences may be customized using a web browser coupled to a service provider.

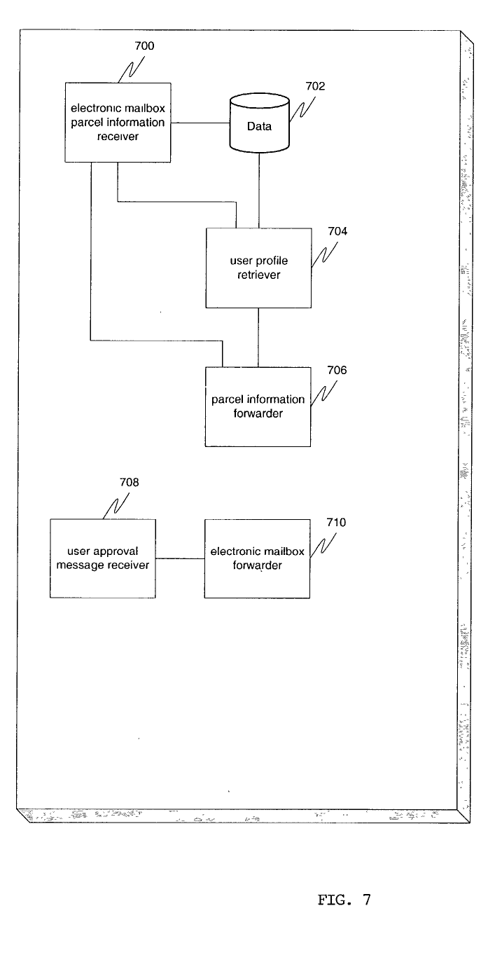

FIG. 7 is a block diagram illustrating an apparatus for coordinating approval of secure parcel delivery to an electronic mailbox in accordance with a specific embodiment of the present invention. An electronic mailbox parcel information receiver 700 may receiver parcel information from the electronic mailbox. The parcel information may be used to retrieve additional parcel information from a database. For example, if the parcel information is data retrieved from a bar code on the parcel, the database may contain information regarding the package linked to the bar code. This database may be maintained by the shipper. Thus, for example, UPS would scan the bar code at the mailbox. The bar code information would then be forwarded to UPS's database where package information such as shipper name could be retrieved. A separate database 702 may contain user profile information. A user profile retriever 704 coupled to the database 702 and to the electronic mailbox parcel information receiver 700 may retrieve a user profile corresponding to the electronic mailbox. A parcel information forwarder 706 coupled to the user profile retriever 704 and to the electronic mailbox parcel information receiver 700 may forward the parcel information to the user as per user preferences described in the user profile. A user approval message receiver 708 may receive an approval message from the user. An electronic mailbox approval message forwarder 710 coupled to the user approval message receiver 708 may forward the approval message to the electronic mailbox to facilitate the opening of an electronic lock on the electronic mailbox.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. An electronic mailbox, comprising:
a mail storage area;
a lock preventing access to said mail storage area; and
a transmitter/receiver coupled to said lock, said transmitter/receiver in wireless communication with a service provider such that a signal received from said service provider may act to open said lock.

2. The electronic mailbox of claim 1, further including a keypad coupled to said lock such that when a predetermined password is entered by a user on said keypad, said lock opens.

3. The electronic mailbox of claim 2, further including a display coupled to said keypad.

4. The electronic mailbox of claim 1, further including a data input device coupled to said transmitter/receiver such that information collected by said data input device is forwarded to said service provider.

5. The electronic mailbox of claim 4, wherein said data input device is a bar code reader.

6. The electronic mailbox of claim 1, further including a Javacard coupled to said transmitter/receiver and said lock.

7. A method for secure parcel receipt at an electronic mailbox, comprising:
receiving information regarding a delivered parcel from a data input device;
forwarding said information to a service provider via a wireless transmitter contained in the electronic mailbox;
receiving an approval response from said service provider via a wireless receiver contained in the electronic mailbox; and
opening said electronic mailbox in response to said approval response via communication to an electronic lock barring access to said electronic mailbox.

8. The method of claim 7, wherein said data input device is a bar code reader.

9. The method of claim 8, wherein said receiving information includes scanning a bar code attached to said parcel with said bar code reader.

10. The method of claim 7, further including opening said electronic mailbox in response to a request to open received from said service provider via said wireless receiver.

11. The method of claim 7, further including opening said electronic mailbox by typing in a password on a keypad coupled to said electronic lock.

12. A method for approving delivery of a parcel to a remote electronic mailbox, comprising:
receiving parcel information from said electronic mailbox on a mobile device;
receiving approval of the delivery of the parcel on said mobile device from a user; and
forwarding said approval to said electronic mailbox to facilitate the opening of an electronic lock on said electronic mailbox.

13. The method of claim 12, wherein said receiving parcel information includes receiving information retrieved from a bar code on the parcel.

14. The method of claim 12, wherein said receiving parcel information includes receiving parcel information from said electronic mailbox via a service provider.

15. The method of claim 12, wherein said forwarding includes forwarding said approval to said electronic mailbox via a service provider.

16. The method of claim 12, further including customizing notification preferences using a web browser coupled to a service provider.

17. A method for coordinating approval of secure parcel delivery to an electronic mailbox, comprising:
receiving parcel information from the electronic mailbox;
retrieving a user profile corresponding to the electronic mailbox;
forwarding said parcel information to said user as per user preferences described in said user profile;
receiving an approval message from said user;
forwarding said approval message to the electronic mailbox to facilitate the opening of an electronic lock on the electronic mailbox.

18. The method of claim 17, further including using said parcel information to retrieve additional parcel information from a database.

19. The method of claim 18, wherein said parcel information is data retrieved from a bar code on the parcel and said database contains information regarding the package linked to said bar code.

20. An apparatus for secure parcel receipt at an electronic mailbox, comprising:
a delivered parcel information receiver;
a service provider parcel information forwarder coupled to said delivered parcel information receiver;
a service provider approval response receiver; and
an electronic mailbox opener coupled to said service provider approval response receiver.

21. An apparatus for approving delivery of a parcel to a remote electronic mailbox, comprising:
a parcel information receiver;
a delivery approval receiver coupled to said parcel information receiver; and
a delivery approval forwarder coupled to said delivery approval receiver.

22. An apparatus for coordinating approval of secure parcel delivery to an electronic mailbox, comprising:
an electronic mailbox parcel information receiver;
a database;
a user profile retriever coupled to said database and to said electronic mailbox parcel information receiver;
a parcel information forwarder coupled to said user profile retriever and to said electronic mailbox parcel information receiver;
a user approval message receiver; and
an electronic mailbox approval message forwarder coupled to said user approval message receiver.

23. An apparatus for secure parcel receipt at an electronic mailbox, comprising:
means for receiving information regarding a delivered parcel from a data input device;
means for forwarding said information to a service provider via a wireless transmitter contained in the electronic mailbox;
means for receiving an approval response from said service provider via a wireless receiver contained in the electronic mailbox; and
means for opening said electronic mailbox in response to said approval response via communication to an electronic lock barring access to said electronic mailbox.

24. The apparatus of claim 23, wherein said data input device is a bar code reader.

25. The apparatus of claim 24, wherein said means for receiving information includes means for scanning a bar code attached to said parcel with said bar code reader.

26. The apparatus of claim 23, further including means for opening said electronic mailbox in response to a request to open received from said service provider via said wireless receiver.

27. The apparatus of claim 23, further including means for opening said electronic mailbox by typing in a password on a keypad coupled to said electronic lock.

28. An apparatus for approving delivery of a parcel to a remote electronic mailbox, comprising:
means for receiving parcel information from said electronic mailbox on a mobile device;
means for receiving approval of the delivery of the parcel on said mobile device from a user; and
means for forwarding said approval to said electronic mailbox to facilitate the opening of an electronic lock on said electronic mailbox.

29. The apparatus of claim 28, wherein said means for receiving parcel information includes means for receiving information retrieved from a bar code on the parcel.

30. The apparatus of claim 28, wherein said means for receiving parcel information includes means for receiving parcel information from said electronic mailbox via a service provider.

31. The apparatus of claim 28, wherein said means for forwarding includes means for forwarding said approval to said electronic mailbox via a service provider.

32. The apparatus of claim 28, further including means for customizing notification preferences using a web browser coupled to a service provider.

33. An apparatus for coordinating approval of secure parcel delivery to an electronic mailbox, comprising:
means for receiving parcel information from the electronic mailbox;
means for retrieving a user profile corresponding to the electronic mailbox;
means for forwarding said parcel information to said user as per user preferences described in said user profile;
means for receiving an approval message from said user;
means for forwarding said approval message to the electronic mailbox to facilitate the opening of an electronic lock on the electronic mailbox.

34. The apparatus of claim 33, further including means for using said parcel information to retrieve additional parcel information from a database.

35. The apparatus of claim 34, wherein said parcel information is data retrieved from a bar code on the parcel and said database contains information regarding the package linked to said bar code.

36. A program storage device readable by a machine, tangibly embodying a program of instructions executable by the machine to perform a method for secure parcel receipt at an electronic mailbox, the method comprising:
receiving information regarding a delivered parcel from a data input device;
forwarding said information to a service provider via a wireless transmitter contained in the electronic mailbox;
receiving an approval response from said service provider via a wireless receiver contained in the electronic mailbox; and
opening said electronic mailbox in response to said approval response via communication to an electronic lock barring access to said electronic mailbox.

37. A program storage device readable by a machine, tangibly embodying a program of instructions executable by the machine to perform a method for approving delivery of a parcel to a remote electronic mailbox, the method comprising:
receiving parcel information from said electronic mailbox on a mobile device;
receiving approval of the delivery of the parcel on said mobile device from a user; and
forwarding said approval to said electronic mailbox to facilitate the opening of an electronic lock on said electronic mailbox.

38. A program storage device readable by a machine, tangibly embodying a program of instructions executable by the machine to perform a method for coordinating approval of secure parcel delivery to an electronic mailbox, the method comprising:
receiving parcel information from the electronic mailbox;
retrieving a user profile corresponding to the electronic mailbox;
forwarding said parcel information to said user as per user preferences described in said user profile;
receiving an approval message from said user;
forwarding said approval message to the electronic mailbox to facilitate the opening of an electronic lock on the electronic mailbox.
